(19) United States
(12) Patent Application Publication
(10) Pub. No.: US 2005/0012295 A1
(43) Pub. Date: Jan. 20, 2005

(54) Two-component running board

(76) Inventors: Donald P. Chevalier, MacTier (CA); Mark Daley-Fell, Washago (CA); Nathan Keith, Huntsville (CA); Brad Newberry, Port Sydney (CA); Shawn Wale, Washago (CA)

Correspondence Address: HARNESS, DICKEY & PIERCE, P.L.C., P.O. BOX 828, BLOOMFIELD HILLS, MI, 48303, US

(21) Appl. No.: 10/620,946

(22) Filed: Jul. 16, 2003

(51) Int. Cl. B60R 3/00

(52) U.S. Cl. 280/163

(57) ABSTRACT

A two-component running board for use with a vehicle comprising a mounting structure supporting a molded step cover. The mounting structure is manufactured from a first material known for its strength, light weight and integrity comprising an optionally integrated means of attaching the molded step cover to the mounting structure without the need for additional hardware or adhesive means. In at least one preferred embodiment, the mounting structure has an integrated means of attaching the two-component running board assembly to the body or sub-frame of the vehicle. The step cover is individualized for each application but comprises an anti-slip step surface on the top side adjacent the vehicle doors, which when installed can support the weight of at least one passenger.

### FIELD OF THE INVENTION

The present invention relates to vehicle running boards, particularly, a two-component running board for use on automotive vehicles.

### BACKGROUND OF THE INVENTION

In recent years running boards have gained popularity for use on four wheel drive vehicles, pick-ups, vans and other vehicles which are supported a substantial distance above the ground. The running boards facilitate entry into the vehicle and also help protect the vehicle from damage caused by rocks and stones thrown by the vehicle wheels.

Presently known running boards usually require a single or multi-component sub-structure to span the vehicle bracket attachments. The sub-structure provides the support to carry the loads to which it is subjected as well as providing a platform to mount cosmetic pieces and step pad surfaces.

The use of multiple components to provide load support, cosmetic and step pad surfaces is time consuming in the manufacturing process, and therefore adds to the expense of the running board. Furthermore, utilizing fasteners in their assembly is even more time consuming, and increases the complexity and number of parts in the assembly, adding to its cost.

In order to minimize the cost of the running boards, most manufacturers use the least amount of material in the board as possible. This often results in weakening of the running board, and many running boards bend or deflect when subjected to the load of a person stepping thereon.

Numerous running boards presently on the market are designed with the ease of manufacturing in mind. Methods such as minimizing the number of components, and manufacturing running boards comprising various composite materials have been employed to lower production costs and the overall weight of the running board as well as simplify installation. U.S. Pat. No. 6,412,799 issued to Oakland, discloses a one-piece running board and mounting assembly for use on a motor vehicle. The main drawback of such an invention being the limited versatility of the running board. To vary the shape, texture, and/or contour of the running board, the entire component must be remolded for each application. Furthermore, one is very limited in vehicle attachment options since mounting brackets and running boards must be considered in tooling limitations, as is styling limited due to the trade-off in molding requirements for the brackets to function properly. Lastly, it is often not possible to attach one-piece brackets on many vehicles.

It is therefore advantageous to create a two-component running board having a universal lower mounting component for attaching the running board to the vehicle, and a upper step component which can vary depending on individual preference with regard to shape, non-skid tread implementation, style and composition. Either mounting component can be manufactured at significantly lower costs in that it needs not be of an aesthetically pleasing material, allowing for a wider range of material options.

### SUMMARY OF THE INVENTION

With regard to the above shortcomings in prior art, it is an object of the present invention to provide for a two-component running board, the molded lower mounting portion having one or more integrated mounting structures, the upper step component being attached thereto.

It is a further object of the present invention to provide a two-component running board where the lower mounting component can be manufactured from a wide range of economically available materials.

Another object of the present invention is to provide a two-component running board having a versatile upper step component providing for individualized style, integrity, and design.

A further object of the present invention is to provide a two-component running board where the lower mounting component embodies a lower substructure plate which shields against rock and road abrasion.

A further object of the present invention is to increase structural load capacity by the permanent combination of the top and the bottom portion to significantly increase the moment of inertia (I).

These and additional objects are achieved in a running board comprising two molded pieces; a lower mounting component having a means to attach the running board to the vehicle, utilizing either mounting hardware or a fastener-less connection, further embodying attachment means for receiving an upper step component, which provides for the tread of the step. The lower component is molded with integral support ribs, to support the full weight of a driver and passengers, and has a generally planar lower side for protecting the integral structure and the vehicle from rock and road abrasion. Covered cosmetically by the upper step component, either the lower or upper component can be manufactured from a more economic material, lowering the overall cost of production.

The upper portion is molded of either the same or different material as that of the lower mounting component, and can attach to the lower mounting component by a variety of attachment means.

The upper component may also vary in design, impact and mar resistance, depending on individual preference, and allows the cosmetics to be of a paintable or other beneficial property type material. Optionally, the upper component may further comprise a number of decorative pieces, some colored or textured to allow a very stylized fit.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of the two-component running board as attached to a vehicle;

FIG. 2 is a perspective, isolated view of the two piece running board, illustrating the pre-combined lower mounting component and the upper step component;

FIG. 3 is a cross-sectional side view taken along line 3 of FIG. 2, illustrating the lower mounting portion and attached upper step component.

### DETAILED DESCRIPTION OF THE PREFERRED EMBODIMENTS

The following description of the preferred embodiment(s) is merely exemplary in nature and is in no way intended to limit the invention, its application, or uses.

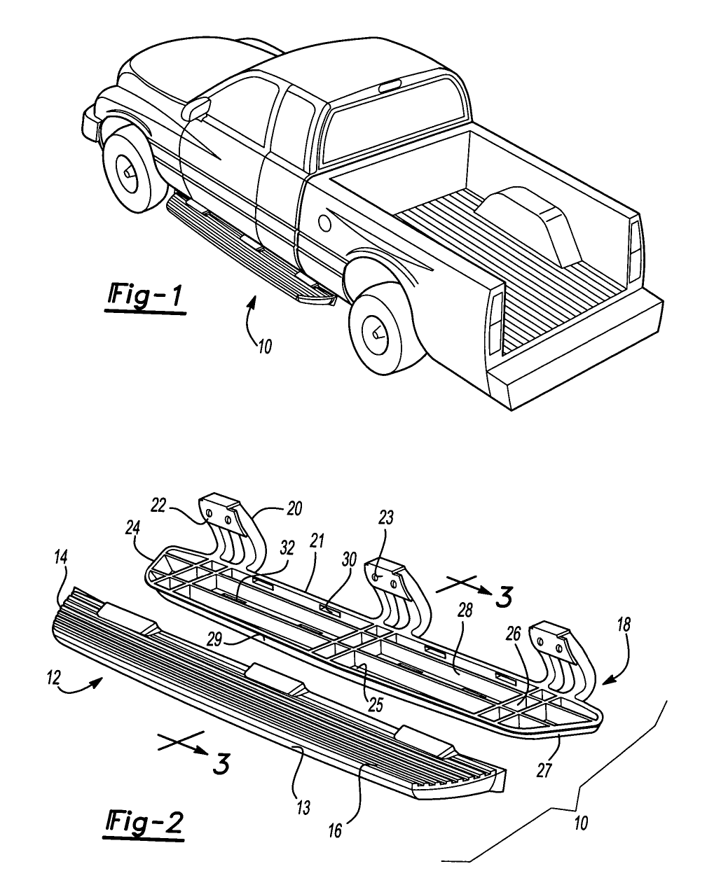

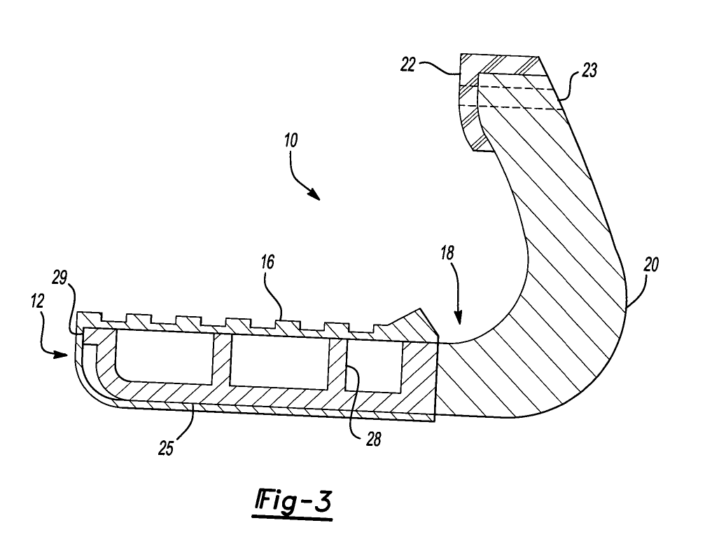

Referring to the figures, specifically FIG. 1, a two-component running board 10 is shown attached to a truck-type motor vehicle. The running board is generally an elongated, planar step attached to the vehicle's body or sub-frame below the vehicle's passenger doors, providing a step to assist in entry and egress from the vehicle. The running board further provides protection to the vehicle body from abrasion due to road debris being thrown from the vehicles tires. It may also provide additional safety in the event of side impact to the vehicle.

FIG. 2 illustrates the two-component running board separate from the vehicle, further showing the upper step component 12 separated from the lower mounting component 18 for illustration of the internal substructures. The lower mounting component 18 comprises a molded unitary component, and in a preferred embodiment, has a plurality of integral attachment means 20 for attaching the lower mounting component 18 to the vehicle. The molded lower mounting component 18 is of a generally planar, elongated structure having a bottom surface 25, front end 24, rear end 27, and inner 21 and outer edges 29. A plurality of integral reinforcing ribs 26, 28 are molded there within, extending from the bottom surface providing enough support to the running board 10 to carry the weight of at least one individual. The upper surface of the lower mounting component 18 is open, and generally planar for accepting the attachment of the upper step component 12. One or more apertures 32 through the bottom surface 25 may be embodied in the mounting component 18 to allow for drainage of any moisture which may be present inside the step 10.

Attachment of the upper step component 12 to the mounting component 18 can be achieved through various methods known in the art including fasteners, welding, or use of an adhesive or snap-fit. In a preferred embodiment, the lower component 18 comprises a plurality of attachment slots 30 for receiving complimentary locking tabs, not shown, but located on the upper step component 12, as a means of attachment not requiring the use of additional fasteners or adhesives.

As mentioned in the preferred embodiment of the present invention, the lower mounting component 18 comprises a plurality of integral attachment means 20 extending from the rear side thereof, and having an overall L-shape. Each attachment means 20 is integrated with horizontal supports running perpendicularly through the running board, proximal each mounting position, which extend vertically to the mounting surface 22 having a plurality of mounting holes 23 there through, for attaching the lower mounting component to a vehicle's body or sub-frame either through utilization of mounting hardware or a fastener-less connection. The exact number, orientation and position of the attachment means 20 varies for each application and is not intended to limit the scope of the present invention.

The lower mounting component 18 is molded from a durable, light-weight and economically available material wherein the aesthetic value of the molded product is of little importance because little is visible after attachment of the upper step component 12 thereto. Furthermore, the lower component 18 provides for a generally planar skid plate, protecting the upper step component 12 and the sides of the vehicle from rock and road abrasion, as well as preventing mud, snow and ice build-up that would otherwise increase the vehicle weight.

The upper step component 12 is complementary to the lower mounting component 18 in that it is received on top of the lower mounting component 18, and in the preferred embodiment has attaching tabs not visible, for being received within attachment slots 30 of the lower component. The upper step component 12 can be varied according to each individual application based on overall style choice and material composition, but generally comprises a flat, upper surface 16 with an anti-slip means either in the form of adhesive grit strips, texturing, or grooves within the upper surface thereof, forming the step surface. In continuation with the upper surface 16 the sides 13, 14 wrap around and may overlap the sides 29 and ends 24, 27 of the lower mounting component 18, forming a horizontal cover when installed. The upper step component 12 may be of the same material as the lower mounting component, but generally is molded from a high-impact resistant composition which can be finished in a plurality of ways depending on the individual application.

Furthermore, the term “component” as used herein is not intended to be limited to a single structural member or element, since the upper step component 12 could comprise two or more separate cover sections arranged end-to-end or side-by-side and still comprise the “step component” of the present invention. Similarly, the lower mounting component 18 could also comprise two or more separate sections arranged end-to-end or side-by-side beneath the upper step component 12 and still comprise a single, bottom “component”.

The description of the invention is merely exemplary in nature and, thus, variations that do not depart from the gist of the invention are intended to be within the scope of the invention. Such variations are not to be regarded as a departure from the spirit and scope of the invention.

1. A two-component running board for a vehicle comprising:
a unitary lower support structure, said structure attaching to a motor vehicle in a generally parallel orientation to said vehicle, positioned below the passenger doors of the vehicle, said structure having a plurality of integral walls, a plurality of crossing walls positioned such as to provide rigidity to the structure;
a step cover, said cover attaching to said supporting structure having a generally planar stepping surface on a top side thereof;
wherein when said support structure is mounted to a vehicle and step cover is attached to said supporting structure forming the running board assembly, the running board assembly can support the weight of at least one vehicle passenger.

2. The two-component running board of claim 1 wherein said lower support structure is made of a first moldable material, and has a generally planar bottom surface.

3. The two-component running board of claim 1 wherein said lower support structure comprises at least one integral mounting means, attaching said support structure to a vehicle, said mounting means supporting the weight of the running board assembly and at least one vehicle passenger.

4. The two-component running board of claim 1 wherein said lower support structure comprises an integral means of attaching said step cover.

5. The two-component running board of claim 1 wherein said step cover is of a second moldable material, and is attached to the lower support structure by a fastening means.

6. The two-component running board of claim 5 wherein said step cover further comprises an anti-slip means on said stepping surface.

7. The two-component running board of claim 5 wherein said fastening means comprises a set of locking tabs integrated in said step cover, for being received in a complementary set of locking slots in said lower support structure.

8. The two-component running board of claim 5 wherein said fastening means comprises machine fasteners.

9. The two-component running board of claim 5 wherein said fastening means comprises a weld.

10. A multiple-piece running board for a vehicle comprising:
at least one lower support structure, said structure attaching to a motor vehicle in a generally parallel orientation to said vehicle, positioned below the passenger doors of the vehicle, said structure having a plurality of integral walls, a plurality of crossing walls, said lower support structure comprising an integral means of attaching a step cover, and further comprising an integral mounting means of attaching said support structure to the vehicle;
at least one step cover, said cover attaching to said supporting structure having a generally planar stepping surface on a top side thereof, said step cover further comprises an anti-slip means on said stepping surface and an integral means of securing said cover to said mounting structure;
wherein when said support structure is mounted to a vehicle and step cover is attached to said supporting structure forming the running board assembly, the running board assembly is able to support the weight of at least one vehicle passenger.
